(19) United States
(12) Patent Application Publication
(10) Pub. No.: US 2017/0074353 A1
(43) Pub. Date: Mar. 16, 2017

(54) Automotive Transmission

(71) Applicant: Ryan Uebel, Roberts, WI (US)

(72) Inventor: Ryan Uebel, Roberts, WI (US)

(21) Appl. No.: 14/849,856

(22) Filed: Sep. 10, 2015

(51) Int. Cl. F16H 1/28; F16H 57/021

(52) U.S. Cl. CPC F16H 1/28; F16H 57/021

(57) ABSTRACT

This invention relates to a method and arrangement for reduction of rotational mass of transmission system of a vehicle to improve its fuel efficiency. The reduction of rotational mass is achieved by replacing the torque converter of an automatic transmission or conventional clutch system of a manual transmission, by a flywheel and a holding device. The flywheel and the holding device are located inside the bell housing of the transmission.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to the field of transmission systems for automobiles. The invention, particularly relates to a method and arrangement for reduction of rotational mass of torque transmission systems.

(2) Background of the Invention

In the past various methods have been adopted to increase the efficiency of the torque transmission system by reducing mass of rotational parts involved in transmitting of torque in either manual or automatic. In the case of the automatic transmission there is literally no way of reducing the rotating mass of the transmission and maintaining the same amount of power going to the transmission. The only way is to lower rotational mass of a torque convertor which is what an automatic transmission uses. To use a smaller torque convertor usually is not a feasible option except on some high performance vehicles used for racing or pulling competitions. This is because the smaller and lighter you make a torque convertor the less power it is able to transfer at the same RPM and that is because there is less surface area inside of it.

Manual transmissions do however have a viable way of reducing rotational mass typically it is an aftermarket modification for performance but does a decent job. This is done by using a lighter flywheel for example an aluminum flywheel will be used with a steel insert where the clutch disk rides. It is a great improvement and a lot of people will do it to improve performance, but is not used in at least 95% of vehicles from the factory.

U.S. Pat. No. 4,416,360 discloses a vehicle drive train comprising an internal combustion engine having an output shaft, a flywheel, and a clutch for selectively connecting the flywheel to the engine output shaft. There is provided an automatic transmission connected to the flywheel for driving the vehicle and a starting motor for turning the flywheel. The starting motor and flywheel are integral parts of the clutch. The internal combustion engine may be controlled by an accelerator lever which is coupled to a position transducer that generates a transducer output signal for generating a shifting signal for controlling the transmission. The accelerator may include an accelerator switch responsive to the position of the accelerator lever to generate a disengaging signal for disengaging the clutch when the accelerator lever is not depressed. With this arrangement, the vehicle is allowed to coast with the internal combustion engine stopped when driving power is not demanded. There may also be provided a manually operated switch means for overriding the disengagement signal and thereby keeping the clutch engaged when the accelerator lever is released. There can also be provided a switch responsive to an operating condition of the engine such as engine temperature, for overriding the clutch disengagement signal.

Another prior art U.S. Pat. No. 6,663,535 discloses a technique for managing torque of an internal combustion engine based upon the operating state of an associated transmission. The technique is for managing torque of a drivetrain. The drivetrain includes an air intake passage having a throttle valve, an internal combustion engine having an output shaft, a transmission having an output shaft, and a rotational propulsion member operatively coupled to the transmission by a propeller a drive axle. The system includes a throttle valve sensor, an engine speed sensor, a transmission speed sensor, a vehicle speed sensor, a transmission controller, and an engine controller. The throttle position sensor provides a throttle position signal that is indicative of a rotational position of the throttle valve. The engine speed sensor provides an engine speed signal that is indicative of a rotational speed of the engine output shaft. The transmission speed sensor provides a transmission speed signal that is indicative of a rotational speed of the transmission output shaft. The vehicle speed sensor provides a vehicle speed signal indicative of a rotational speed of the rotating propulsion member. The transmission controller provides a transmission operation signal that is indicative of an operating state of the transmission. The engine controller is response to all of the signals to provide a fueling meter signal to a fueling system that is indicative of a level of fuel to be supplied to the engine. The engine output shaft generates a torque in response to the fueling meter signal that is within the torque capacity of each component of the drivetrain.

Another prior art U.S. Pat. No. 8,967,007 discloses a rotatable input member and a rotatable mass. There is also a member with an eccentric offset, with the rotatable mass being rotatably coupled to the offset and being eccentric with respect to the offset. The input member is coupled to the rotatable mass by a linkage so that the rotation of the input member causes the rotatable mass to rotate about the offset. First and second one-way clutches transfer torque from the offset member to the output member. The first one-way clutch drives the output member in one direction when the eccentric offset member is driven in the same direction, and the second one-way clutch prevents the output member from rotating in the opposite direction.

Another prior art U.S. Pat. App. 20120234131 discloses a dual-mass flywheel is provided for a vehicle drivetrain having an internal combustion engine and a transmission. The dual-mass flywheel includes a primary mass adapted for connection to the engine and a secondary mass operatively connected to the primary mass and adapted for connection to the transmission. A clutching mechanism is configured to lock the secondary mass to the primary mass up to a threshold speed of the engine to reduce noise, vibration, and harshness (NVH) during start-up of the engine. The clutching mechanism is also configured to release the secondary mass from the primary mass above the threshold speed. The arrangement of current invention almost entirely eliminates rotational mass and the friction material of the clutch that would be replaceable in a relatively small amount of time without removing the transmission unless the flywheel is damaged beyond use. Any and all other manual transmissions used today do need the transmission to be removed from the engine, to replace the friction of the clutch because the input shaft of the transmission goes directly through the center of the clutch friction material. The design of current invention is such that it does not require the transmission to be removed from the engine to replace friction of clutch, which is another key aspect. The design is very much cheaper to maintain and repair; it could also lower the cost of manufacturing because parts that are already in production could be used like a brake rotor as a flywheel and brake pads. These parts are used to hold the flywheel. The design will also reduce the number of different parts needed to make the vehicle, reducing to some extent warehouse space part numbers, paper work and suppliers needed to produce the vehicle.

### SUMMARY OF THE INVENTION

In the view of the foregoing disadvantages inherent in torque transmission systems now present in the prior art, the present invention provides low rotational mass transmission. As such, the general purpose of the present invention, which will be described subsequently in greater detail, is to provide a new and improved torque transmission which has all the advantages of the prior art and none of the disadvantages.

An object of the invention is to provide a rotational energy or torque transmission system having reduced rotational mass.

It is another object of the present invention to provide an arrangement by which rotational energy or torque is transmitted to either the transmission or flywheel based on what is easier.

It is another object of the present invention to provide an automatic transmission system in which a flywheel and a holding device, replace a torque converter.

It is another object of the present invention to provide a manual transmission system in which a flywheel and a holding device, replace a conventional clutch system.

It is another object of the present invention to provide an arrangement inside an automatic transmission where a main fluid pump driven by a torque convertor is moved to the bell housing.

It is another object of the present invention to provide a torque transmission system which almost entirely eliminates rotational mass.

It is another object of the present invention to provide a transmission system i.e. both automatic and manual, in which the friction material of the clutch is replaceable in relatively small amount of time without removing the transmission.

It is yet another object of the present invention to provide a torque transmission system that is cheaper to maintain and repair.

It is yet another object of the present invention to provide an arrangement that helps reduce overall cost of manufacturing as parts already in production could be used.

It is yet another object of the present invention to provide more fuel efficient vehicle.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows the preferred embodiment of current invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

Advantageously, the present invention is different from the existing knowledge. The mechanics of the assembly work by sending rotational energy or torque to either the transmission or the flywheel based on what is easier to turn. If the flywheel is being held, than torque will more easily go through the transmission. This is accomplished with the planetary gear set. Torque comes to the gear set at the sun gear and the sun gear spins which in turn turns the planet gears that are placed around the sun gear. The planet gears are attached to the carrier at their axle.

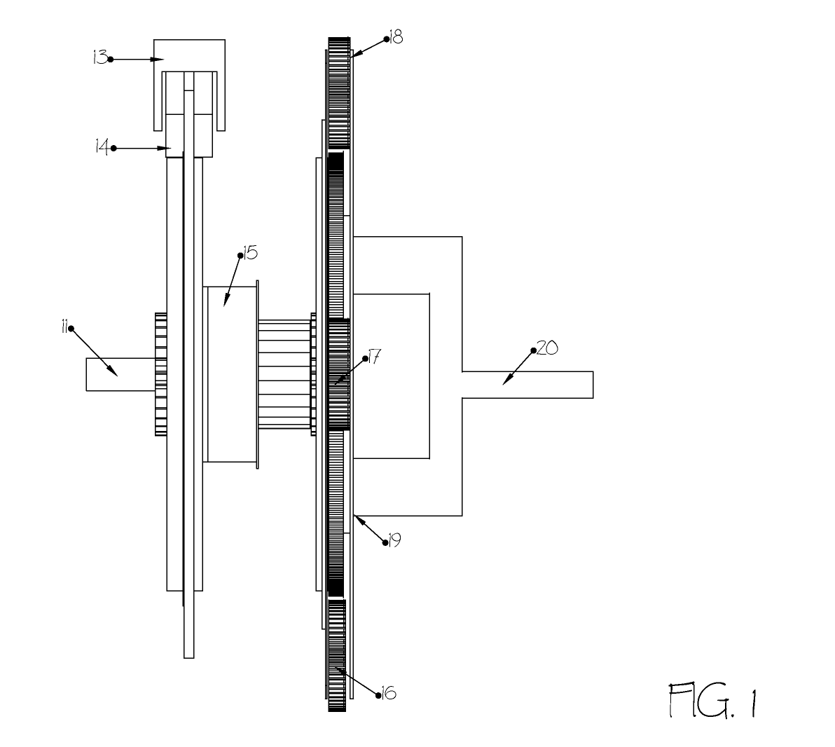

The FIG. 1 shows the arrangement 10 of the current invention. The drive shaft 11 from the engine of the vehicle is splined to sun gear 17. The flywheel 12 is held by the holding device 13. More than one may be used or needed as per requirement of the transmission system. The FIGURE also shows the friction material 14 of the clutch that would be replaceable in a small amount of time without removing the transmission unless the flywheel 12 is completely damaged. The flywheel mounting flange 15 is splined to ring gear 18. The ring gear 18 drives off planet gears 17 and is connected to the flywheel 12. The sun gear surrounded by the planet gears of the gear set is driven from engine through drive shaft. Input shaft 20 is connected to the planet gear carrier, and transits torque to the transmission.

If the ring gear is held by flywheel, then the planet gears will start to turn their carrier in turn sending torque to the wheels. If the ring gear is not held by the flywheel, the planet gears will turn the ring gear and the flywheel instead of the input shaft to the transmission. In these two scenarios, the goal of starting and stopping the vehicle while keeping the engine running is accomplished by this design. It is not something that can be added to an existing vehicle it will need to be designed and built in to the vehicle from the factory.

If it is used in an automatic transmission the pump will need to be repositioned to the bell housing between the engine and the flywheel and powered by the same shaft that sends power to the sun gear, and appropriate more than likely computer control for the application of the holding device will be needed.

The only way is to lower rotational mass of a torque convertor, which is what an automatic transmission uses. Using a smaller torque convertor usually is not a feasible option except on some high performance vehicles used for racing or pulling competitions. This is because the smaller and lighter you make a torque convertor the less power it is able to transfer at the same RPM and that is because there is less surface area inside of it.

Eventually, based on power of the engine, torque converter will transfer all the engines power to the transmission but at a much higher RPM which is why it is used in racing and other competition. These units are known generally as stall convertors, one would generally pick a stall convertor to keep his engine in its peak power RPM which is much higher than one would typically need for normal driving. They are usually classified by their size such as a 10″ or and 8″ convertor an eight inch convertor would allow the engine to run at a higher RPM than the 10″. The other way they are classified is such as a 3500 RPM stall convertor this means that the engine will not be able to go any faster than 3500 RPM without turning the input shaft of the transmission but this is relative to horse power of the engine within reason. This also means that the engine RPM is going to need to be higher to start moving the vehicle thus being less efficient. This is also sometimes necessary for cars that have modified engines and are still driven on the roads, because the engine is modified usually to make more power at higher RPMs, and tend to make less power at lower RPMs and do not have enough power to start moving the vehicle from a stop with the stock convertor, so a stall converter is installed to allow higher RPM to get the car moving. This whole process is known as torque amplification. The manual transmissions that use a clutch are not concerned with this because power is directed to the wheels by the driver manually through the clutch controls if more power or RPM is needed the driver just releases the clutch slower.

This design of current invention has more advantages when used in an automatic there would be much less fluid needed possibly as much as half, and much less heat would be generated which means the vehicle may need less components to operate like coolers and lines all making the vehicle cheaper to build and cheaper to repair and maintain.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. An arrangement for reduction of rotational mass of a torque transmission system, the arrangement comprising:
a flywheel;
a holding device; and
a planetary gear set.

2. The arrangement according to claim 1, wherein said flywheel and said holding device are located inside a bell housing of a transmission system.

3. The arrangement according to claim 1, wherein said holding device is mounted through an opening on one side of said bell housing.

4. The arrangement according to claim 1, wherein said holding device is mounted on one side of said bell housing in such a way that it engages with said flywheel.

5. The arrangement according to claim 1, wherein one or more said holding device can be mounted on one side of said bell housing.

6. The arrangement according to claim 1, wherein said planetary gear set is located inside said transmission system.

7. The arrangement according to claim 1, wherein said planetary gear set has a sun gear positioned in middle of two or more planetary gears.

8. The arrangement according to claim 1, wherein said planetary gear set is made up of two or more planetary gears and a planet gear carrier.

9. The arrangement according to claim 8, wherein two or more planetary gears of said planetary gear set, are mounted on said planet gear carrier.

10. The arrangement according to claim 8, wherein said planet gear carrier powers an input shaft, to said transmission system.

11. The arrangement according to claim 8, wherein said sun gear is powered by a crankshaft of an engine.

12. The arrangement according to claim 1, wherein a ring gear is at distal end of said planetary gear set.

13. The arrangement according to claim 12, wherein said ring gear goes around the circumference of two or more planetary gears and engages them.

14. The arrangement according to claim 12, wherein said ring gears also connects to said flywheel.

15. The arrangement according to claim 1, wherein a main fluid pump inside an automatic transmission driven by a torque convertor is moved to said bell housing.

16. The arrangement according to claim 15, wherein an output shaft that connects engine to transmission, goes through said main fluid pump.

17. The method for transmission of rotational energy or torque, the method comprising:
(a) providing a flywheel and a holding device that replace a torque converter in an automatic transmission;
(b) providing said flywheel and said holding device that replace a conventional clutch system in a manual transmission;
(c) providing a sun gear of a planetary gear set to transmit torque;
(d) providing said sun gear that turns two or more planetary gears placed around it;
(e) providing torque transmission to a carrier of two or more planetary gears by two or more planetary gears, when a ring gear is held by a flywheel;
(f) providing torque transmission to a plurality of wheels by said carrier of two or more planetary gears;
(g) providing turns to said ring gear and said flywheel with two or more planetary gears in place of an input shaft to a transmission system, when said ring gear is not held by said flywheel.
